(19) United States
(12) Patent Application Publication
(10) Pub. No.: US 2022/0188828 A1
(43) Pub. Date: Jun. 16, 2022

(54) TRANSACTION GENERATION FOR ANALYTICS EVALUATION

(71) Applicant: International Business Machines Corporation, Armonk, NY (US)

(72) Inventors: Shuyan Lu, Cary, NC (US); Guandong Zhu, Raleigh, NC (US); Yi-Hui Ma, Mechanicsburg, PA (US); Junhui Wang, Cary, NC (US); Chuan Ran, Morrisville, NC (US)

(21) Appl. No.: 17/118,233

(22) Filed: Dec. 10, 2020

(51) Int. Cl. G06Q 20/40

(52) U.S. Cl. CPC G06Q 20/4016

(57) ABSTRACT

A system receives transaction parameters which indicate a type of fraud. The system generates a set of sample transactions based on the parameters. The set of sample transactions generated by the system include at least one fraudulent transaction consistent with the type of fraud indicated by the parameters. The system can then send the transaction to an analyzer. Upon receiving results from the analyzer, the system evaluates performance of the analyzer.

### BACKGROUND

The present invention relates to analytics and, more particularly, generation of sample transactions for evaluation of analytics systems.

As technology has advanced, fraudulent schemes have become increasingly complex. In particular, financial fraud can be particularly difficult to evaluate and detect. This is enhanced by malicious actors' attempts to disguise the fraud. Systems designed to monitor for and detect financial fraud may, for example, monitor transactions between various parties and/or accounts and attempt to detect patterns that are consistent with known patterns. Many modern analysis systems utilize various forms of artificial intelligence and/or machine learning.

### SUMMARY

Some embodiments of the present disclosure can be illustrated as a method. The method comprises receiving a set of transaction parameters indicating a type of fraud. The method further comprises generating, based on the transaction parameters, a set of sample transactions, at least one of which is consistent with the indicated type of fraud. The method further comprises transmitting the set of sample transactions to an analyzer. The method further comprises receiving results from the analyzer. The method further comprises evaluating, based on the results, performance of the analyzer

Some embodiments of the present disclosure can also be illustrated as a computer program product comprising a computer readable storage medium having program instructions embodied therewith, the program instructions executable by a computer to cause the computer to perform the method discussed above.

Some embodiments of the present disclosure can be illustrated as a system. The system may comprise memory and a central processing unit (CPU). The CPU may be configured to execute instructions to perform the method discussed above.

Some embodiments will be described in more detail with reference to the accompanying drawings, in which the embodiments of the present disclosure have been illustrated. However, the present disclosure can be implemented in various manners, and thus should not be construed to be limited to the embodiments disclosed herein.

The above summary is not intended to describe each illustrated embodiment or every implementation of the present disclosure.

### BRIEF DESCRIPTION OF THE DRAWINGS

The drawings included in the present application are incorporated into, and form part of, the specification. They illustrate embodiments of the present disclosure and, along with the description, serve to explain the principles of the disclosure. The drawings are only illustrative of certain embodiments and do not limit the disclosure. Features and advantages of various embodiments of the claimed subject matter will become apparent as the following Detailed Description proceeds, and upon reference to the drawings, in which like numerals indicate like parts, and in which:

FIG. 1 is a high-level method for generating sample transactions, consistent with several embodiments of the present disclosure.

FIG. 2 is a diagram of a sample transaction generation system, consistent with several embodiments of the present disclosure.

FIG. 3 depicts an example table of sample transactions, consistent with several embodiments of the present disclosure.

FIG. 4 illustrates a high-level block diagram of an example computer system that may be used in implementing embodiments of the present disclosure.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention.

### DETAILED DESCRIPTION

Aspects of the present disclosure relate to systems and methods to evaluate fraud analytics systems. More particular aspects relate to a system to generate sample transactions based on received profile settings, transmit the sample transactions to an analyzer, receive classifications from the analyzer, and evaluate performance of the analyzer.

Transactions, such as bank transfers, purchases, payments, etc., are recorded and mapped in “transaction networks.” A transaction network comprises a group of nodes connected by edges, where each node represents an account and each edge connecting two nodes representing a transaction between the two nodes. As the number of accounts and transactions has grown over time, financial transaction networks have accordingly grown increasingly large and complex and continue to evolve. This presents a growing problem for financial institutions that are generally tasked with monitoring their own networks to detect fraud. Further, institutions are often required by law to maintain some level of fraud detection systems, though these laws vary by jurisdiction and are prone to change. Thus, analyzers of transaction networks need to be robust. Further, many laws require institutions to maintain analysis systems that meet certain (often-changing) standards.

Another common problem in the field of fraud detection is a general lack of test data, meaning data that can be used to train or evaluate. This can cause several problems; for example, training systems to detect financial fraud can be particularly difficult. In addition, changing methods of fraud may not be represented in existing test data, bringing about a demand for newer test data. While many systems may attempt to utilize existing transaction data (such as the actual data being monitored) as test data, test data must typically be known (e.g., identified as fraudulent, innocuous, etc.) in order to be useful for training. In other words, merely suspecting a transaction of being fraudulent is generally insufficient for the transaction to qualify as test data. Systems generally struggle to identify fraudulent transactions with the level of certainty needed to enable usage of the transactions as test data, resulting in a dearth of usable “real” data, particularly when compared to the scale of test data required to train artificial intelligence models. Thus, systems and methods of the present disclosure are particularly advantageous, as they enable generation of customized test data in the field of financial transactions. The sample transactions may include randomized amounts, parties, and times. Each transaction may have a randomly-selected counterparty (i.e., a second party to a transaction, such as a receiver of a funds transfer). In some instances, a transaction may only have a single party, such as a deposit.

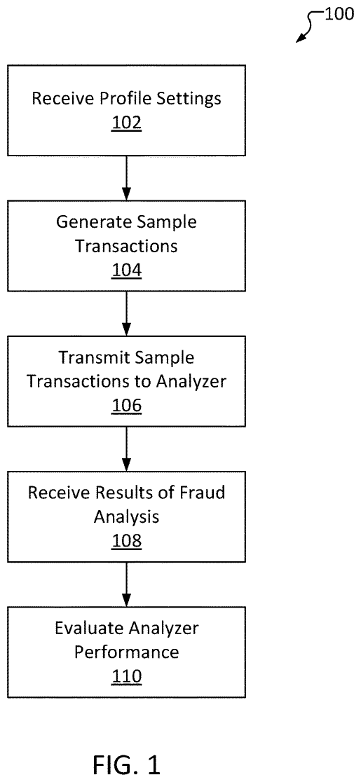

FIG. 1 is a high-level method 100 for generating sample transactions, consistent with several embodiments of the present disclosure. Method 100 comprises receiving profile settings at operation 102. Operation 102 may include receiving a set of parameters describing sample transactions to be generated. The set of parameters can be used to dictate generation of a set of sample transactions. For example, the parameters may describe a type (or types) of fraud the transactions should simulate (if any). As an illustrative example, a first parameter may indicate that the set of sample transactions should include transactions to a sanctioned entity (such as a nation). As another example, the first parameter may indicate that the set of sample transactions should include deposit limit circumventions (i.e., making multiple smaller deposits in an attempt to deposit, in aggregate, over a particular limit without triggering detection). In some instances, the first parameter may indicate that the set of sample transactions should be “innocent” (meaning they do not include any fraudulent activity). In some instances, the first parameter may indicate more than one type of fraud. In some instances, multiple sets of settings can be received from multiple profiles.

Method 100 further comprises generating sample transactions at operation 104. Method 100 may include, for example, generating a set of transactions. Each of the set of transactions may include a party (or parties) to the transaction. For example, a sample transaction may include a first (sending) party and a second (receiving) party. In some instances, the transaction may only include a single party (e.g., for deposits/withdrawals). The parties may be generated as part of operation 104, or can be selected from a pool of existing parties.

A sample transaction also includes a transaction amount, as well as a “direction” of the amount. For example, a sample transaction could include an amount of $400, and indicate that the $400 was sent from a first party to a second party. An example transaction can also include a timestamp of the transaction, indicating a time and/or date of the transaction. Example transactions may also include an origin and/or destination of the transaction (such as, for example, a nation, state, etc.). As an example, a sample transaction may indicate that a first party in the United States transferred $400 to a second party in Canada. In some instances, sample transactions may include a type of transaction. For example, a sample transaction may be a wire transaction, a check, or the like.

In generating a transaction with multiple parties, a system performing method 100 may “lock” the party relationship to ensure parity of transaction parties. As an example, a system performing method 100 may generate information describing all transactions involving a first party (e.g., a list of all transactions wherein the first party is the sender or recipient of funds). A first transaction may include the first party sending funds to a second party. The system may also generate a second list of all transactions involving the second party. Due to the “locked” party relationship, the second list will include the first transaction, wherein the second party received funds from the first party. In essence, this may help simulate the “networked” nature of transactions.

The sample transactions may be generated based on the profile settings received at operation 102. For example, the profile settings may indicate an amount or range of amounts for the sample transactions. The profile settings may also indicate a type of fraud for the transactions to represent. For example, the profile settings may indicate that the sample transactions should include a number of “deposit limit circumvention” transactions. In such an example, operation 104 may include generating a set of sample transactions representing a single party making multiple deposits in a short timespan. The sample transactions may be generated such that amounts of the deposits are individually below a deposit limit but, when combined (i.e., summed), exceed the deposit limit. In some instances, the profile settings may also affect party relationships. For example, profile settings may include a list of frequent transaction counterparties, wherein, in generating the transactions, parties are matched to transactions. The list of counterparties may influence the matching, such as by weighting a random selection. In some instances, the matching may be statistically based on other factors such as transaction frequency, transaction amount, location(s), etc.

In some instances, operation 104 may include generating one or more “buffer” transactions as part of the set of sample transactions. As used herein, a “buffer” transaction refers to a transaction that does not represent any particular type of fraud, but is included in a set of generated transactions to ensure that an analyzer is able to accurately distinguish between fraudulent and innocuous transactions. For example, operation 104 may include generating three deposit transactions by a first party that, when combined, exceed a deposit limit, as well as a fourth transaction from the first party to a second party that is irrelevant to the deposit limit circumvention.

In some embodiments, more than one set of profile settings may be received; thus, operation 104 may further include generating sample transactions based upon multiple different transaction parameters. For example, a system may receive a first set of profile settings describing a first type of fraud and a second set of profile settings describing a second type of fraud. In response, operation 104 may include generating a set of sample transactions, wherein a first subset of the sample transactions depict the first type of fraud and a second subset of the sample transactions depict the second type of fraud.

Further, operation 104 may include tagging transactions as they are generated in order to enable tracking of the transaction and evaluation of the analyzer. For example, a first sample transaction may be tagged with a first tag, the first tag indicating that it was generated in accordance with a first set of profile settings. Similarly, a second sample transaction may be tagged with a second tag, the second tag indicating that the second sample transaction was generated in accordance with a second set of profile settings. Thus, when the system eventually receives analysis results from an analyzer (discussed below), the system is able to effectively evaluate analyzer performance.

Method 100 further comprises sending the sample transactions to an analyzer at operation 106. The analyzer can be external. For example, in some instances, operation 106 may include transmitting the sample transactions to a machine learning fraud detection system. In some instances, operation 106 may include displaying the sample transactions to a reviewer. In instances involving transactions generated based upon multiple profiles, the sample transactions may be “bundled” or otherwise “comingled”; in other words, transactions generated in accordance with a first set of profile settings may be included in the set along with transactions generated in accordance with a second set of profile settings. Further, the transactions may be arranged so as to conceal that they are in distinct subsets; for example, if the set of transactions are sent as an array (as a list), the various transactions may be randomly “shuffled” so that they do not appear in any particular order.

When the transactions are sent to the analyzer, tags indicating whether the transactions are fraudulent may be withheld. This may prevent an analyzer from simply reading the tags in order to determine whether transactions are fraudulent. In order to enable evaluation of the analyzer's results, the system may keep (record) a “full” copy of the set of sample transactions sent to the analyzer. In other words, operation 106 may include saving a copy of the set of sample transactions, modifying tags of the copy of the set of sample transactions to remove fraud type information, and then transferring the copy of the set of sample transactions to an analyzer.

Method 100 further comprises receiving results of fraud analysis at operation 108. Operation 108 may include, for example, receiving a classification indicating whether the set of sample transactions includes a fraudulent transaction. For example, operation 108 may include receiving an indication that the analyzer has detected transactions of funds to a sanctioned entity. In some instances, operation 108 may include receiving a classification for each transaction. For example, operation 108 may include receiving a first classification indicating that a first sample transaction is innocuous, a second classification indicating that a second sample transaction is a part of a deposit limit circumvention scheme, etc.

Method 100 further comprises evaluating performance of the analyzer at operation 110. Operation 110 may include, for example, calculating a score based on a number of correct classifications and a number of incorrect classifications. As an example, an analyzer may have classified two transactions correctly and three transactions incorrectly, and operation 110 may include assigning a score of 40% to the analyzer. In some instances, trends in the analyzer's results may be identified; for example, if the analyzer consistently misclassifies “deposit limit circumvention” as “innocuous,” operation 110 may include flagging the analyzer as unable to identify “deposit limit circumvention” transactions.

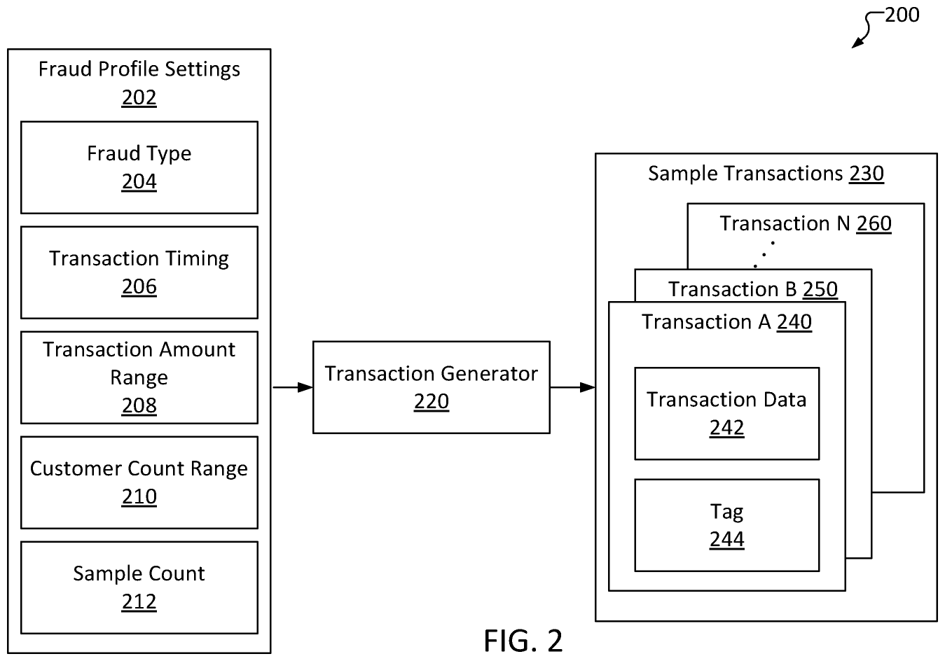

FIG. 2 is a diagram 200 of a sample transaction generation system, consistent with several embodiments of the present disclosure. Diagram 200 depicts fraud profile settings 202, which are input to a transaction generator 220. Transaction generator 220 generates a set of sample transactions 230 based on the received profile settings 202. Sample transactions 230 may be used in evaluation and/or training of one or more fraud analyzers.

Each of sample transactions 230 may include transaction data and a tag. As an example, transaction A 240 includes transaction data 242, which describes the transaction itself (including, for example, an amount of the transaction, a timestamp, parties to the transaction, etc.). Transaction A 240 also includes tag 244, which includes information describing profile 202, such as an identification (ID) number. Tag 244 may be particularly useful in instances including multiple sets of fraud profile settings in addition to settings 202. Tag 244 may also include a type of fraud represented by transaction 240. Tag 244 may also include other transactions of sample transactions 230 included in a pattern of fraudulent transactions. As an illustrative example, tag 244 may indicate that transaction A 240 and transaction N 260 are both part of a “deposit limit circumvention” scheme, wherein both transactions 240 and 260 may be deposits whose transaction amounts are individually below a single deposit limit, but when combined exceed the limit. Some or all of the information included in tag 244 may be modified, omitted, encrypted, or otherwise obfuscated prior to sending sample transactions 230 to an analyzer. Transaction B 250 may similarly include its own transaction data and tag, and so on for each of sample transactions 230 (up to transaction N 260).

In some embodiments, transactions may be tagged as a group, rather than individually. For example, sample transactions 230 may be divided into one or more subsets, each subset being tagged depending upon its originating profile, fraud type, or the like.

Profile settings 202 can be modified by a user to adjust how transaction generator 220 generates transaction data 230. For example, a user may set fraud type 204 to “sanctioned entity.” In response, upon receipt of profile settings 202, transaction generator 220 may generate sample transactions 230 such that at least one sample transaction (for example, transaction A 240) resembles a transaction to a sanctioned entity. Transaction timing 206 can affect timestamps of generated transactions. For example, transaction timing 206 may include a transaction frequency, wherein a relatively high transaction frequency may result in a timestamp of transaction A 240 (included in transaction data 242) and a timestamp of transaction B 250 being relatively similar. This can simulate attempts to obfuscate fraudulent transactions with a flurry of innocuous transactions, resulting in enhanced evaluation of a fraud analyzer. In some instances, transaction timing 206 may also include a total range of transaction timestamps; for example, transaction timing 206 may describe a total time elapsed between a first transaction of a sample transaction set and a latest transaction of the sample transaction set, as well as an average frequency of transactions within the set. As an illustrative example, transaction timing 206 may indicate that sample transactions 230 must range from January 1 to February 25, with an average transaction frequency of one transaction every 10 days.

Transaction amount range 208 may control a range of amounts of sample transactions 230. For example, an amount range 208 of $10,000-$100,000 may cause transaction generator 220 to generate sample transactions 230 such that the amount of each transaction is within the range of $10,000-$100,000. Transaction amount range 208 may also include variables to weight a distribution of the transaction amounts.

Customer count range 210 describes a number of “customers” (e.g., parties) to be simulated in sample transactions 230. As an example, a customer count range of 1-2 may result in transaction A 240 being a withdrawal by a first party, transaction B 250 being a transfer from a second party to the first party, and transaction N 260 being a deposit by the second party. As an additional example, a customer count range of 1 may result in all of sample transactions 230 being deposits or withdrawals by the same party. Customer count range 210 may include a range of customers (to introduce randomness into sample transactions 230). For example, a customer count range of 4-6 may result in transaction generator 220 selecting a count from the range of 4-6 (for example, 5), and then generating sample transactions 230 including transactions between any of 5 different parties. In general, higher values of customer count range 210 result in more complex transaction networks represented by sample transactions 230. Sample count 212 may control a number of transactions to be generated. In general, larger sets of sample transactions 230 may be more useful in evaluating (or training) an analyzer. In some instances, sample count 212 may be generated based upon range and frequency information in transaction timing 206.

As a general principle, data analysis systems may perform more effectively on varied datasets. Thus, transaction generator 220 may implement one or more statistical distribution algorithms when generating sample transactions 230 in order to improve variability. Transaction generator 220 may introduce randomness for each transaction via, for example, the Monte Carlo Method. As an example, a timestamp of transaction A 240 may be 5:00 AM January 1. Transaction generator 220 may generate a timestamp of transaction B 250 by first generating a transaction “time gap” (meaning a time elapsed between transactions). The transaction time gap may be selected via a Poisson Distribution over a total range of transaction dates using the transaction frequency as a lambda. Thus, transaction generator 220 may generate a transaction time gap of 3 days and 4 hours. Transaction generator 220 may then add the transaction time gap to the timestamp of the transaction A 240 in order to generate a timestamp of transaction B 250 (resulting in a timestamp of 9:00 AM January 4). Transaction amounts can be generated using a LogNormal distribution. Such techniques can prevent sample transactions 230 from being similar (or even identical) to one another, while still reliably simulating fraudulent activity.

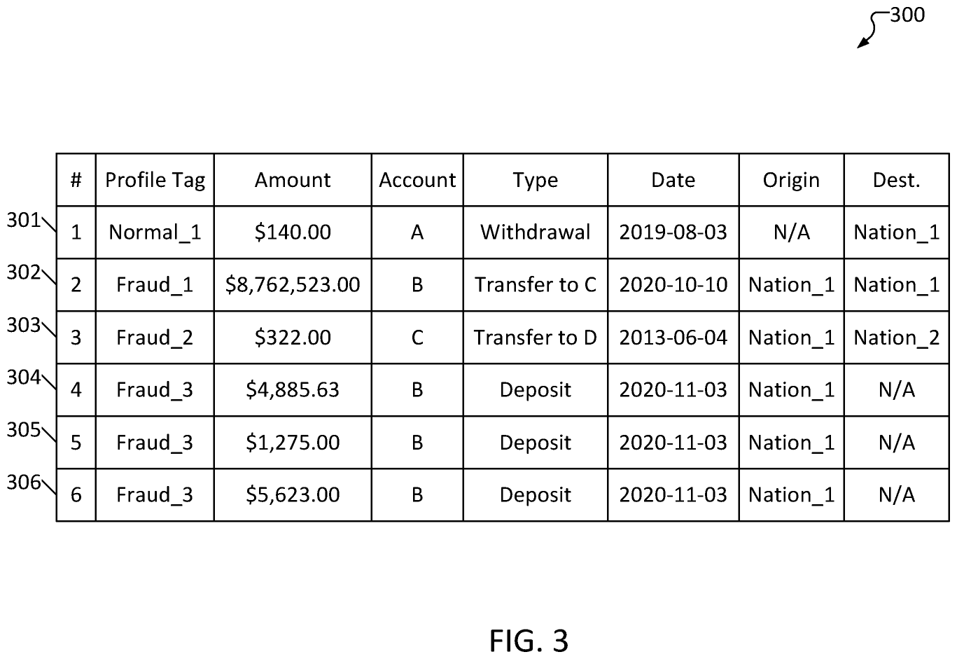

FIG. 3 depicts an example table 300 of sample transactions 301-306, consistent with several embodiments of the present disclosure. Transactions 301-306 may be sample transactions such as, for example, sample transactions 230 generated by a transaction generator such as transaction generator 220 (discussed above with reference to FIG. 2).

Transactions 301-306 include an ID number and an originating profile. The originating profile describes which profile (e.g., fraud profile settings 202) controlled generation of the transaction. For example, transaction 301 was generated in accordance with a profile tagged as “Normal_1” (a profile of innocuous transactions). Transactions 301-306 also include an amount of the transaction. For example, transaction 302, generated in accordance with profile fraud_2, has an amount of $8,762,523.00. Transactions 301-306 also include an account performing the transaction. While presented in FIG. 3 as a single letter (A, B, etc.), in some instances the account may be a generated account number. The number of different accounts may be determined by a profile setting.

Notably, accounts may not be tied to profiles; for example, transaction 302, generated in accordance with profile “Fraud_1,” is originating from account “B.” However, transaction 304, generated in accordance with profile “Fraud_3” (a different fraud profile than “Fraud_1”) also originates from account “B.” This comingling may increase variety in transactions 301-306 and inhibit an analyzer from leveraging metanalysis of transactions 301-306 in order to “cheat” evaluation, intentionally or inadvertently. Thus, comingling may improve the sample data's usefulness in both evaluating and training. However, the option to force different profiles to yield distinct accounts is also considered.

Transactions 301-306 also include a transaction type and a counterparty, if any. For example, transaction 305 is a “deposit” (no counterparty) while transaction 303 is a “transfer to D” (counterparty=account D). Where transactions include a counterparty, the counterparty may be selected from a list of parties. The counterparty may be selected via, for example, a Bernoulli distribution. Other transaction types include withdrawals (as in transaction 301). In some instances, a transaction type may include more specific details; for example, a deposit may be tagged as being a cash deposit, at an ATM, etc., while transfers may be tagged as money orders, cashed checks, and the like.

Transactions 301-306 also include a timestamp; in FIG. 3, this is depicted as a “date,” but higher resolution timestamps are also considered (down to fractions of a second). This may simulate automated systems performing multiple transactions simultaneously, which may in turn enable evaluation of detection of such systems.

Transactions 301-306 also include information describing localities of the transaction, such as an origin and destination of funds. For example, transaction 306, being a deposit, may only have an “origin” but not a “destination.” Transaction localities may be nations, states, specific bank locations, etc. Some simple types of fraud, such as transfers to a sanctioned entity, may be simulated simply through setting a destination field to the sanctioned entity.

The varied nature of transactions 301-306 enable a robust evaluation of an analyzer and its performance in distinguishing various types of fraud. As a simple example, an analyzer may return that transaction 302 and 303 are fraudulent while transactions 301 and 304-306 are innocuous. As the amounts, type, and timestamps of transactions 304-306 are consistent with a deposit limit circumvention attempt, the analyzer's response may indicate that the analyzer is ineffective at distinguishing deposit limit circumventions from innocuous activity. In more complicated examples (involving hundreds of sample transactions or more), analyzers can be evaluated in more detail; for example, an analyzer may struggle to distinguish between a first type of fraud and a second type of fraud if the corresponding transactions have relatively low amounts. Such patterns can be detected, given a large enough set of sample transactions.

Further, control of the fraud profile settings enables customized, targeted testing of analyzers. This can be advantageous in evaluating analyzers prior to a scheduled test. For example, if a regulatory entity has a specific known testing methodology, systems and methods consistent with the present disclosure can enable replicating the entity's testing in order to focus improvements to the analyzer to ensure it meets requirements.

In some instances, every transaction generated in accordance with a given profile dictating a first type of fraud may be consistent with the first type of fraud. For example, a first profile may indicate that transactions should simulate a transfer to a sanctioned entity; in some instances, every transaction generated in accordance with such a first profile may be sample transactions to a sanctioned entity. In view of this, at least one profile requiring “innocuous” transactions may be preferable, to ensure that a resulting set of sample transactions will require an analyzer to be able to distinguish between fraudulent and innocuous transactions. In some instances, a profile may indicate multiple types of fraud, wherein each transaction has a chance of representing one of the given types (or multiple, if possible). In some embodiments, a transaction generator may include “buffer” innocuous transactions in any set of sample transactions (i.e., regardless of profile settings).

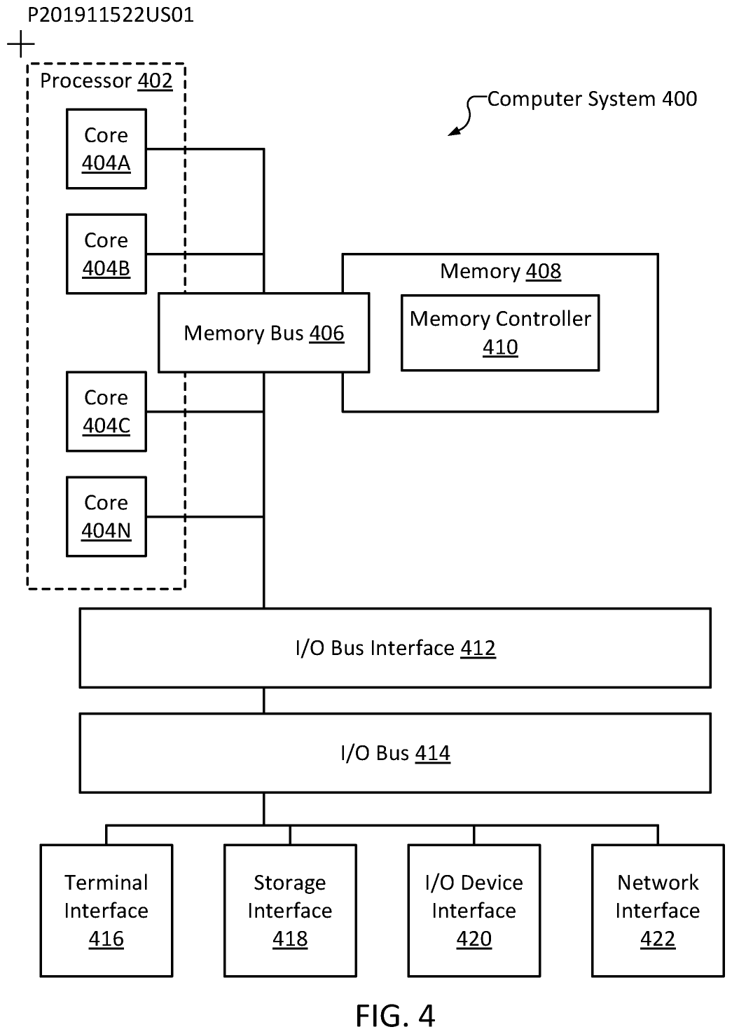

Referring now to FIG. 4, shown is a high-level block diagram of an example computer system 400 that may be configured to perform various aspects of the present disclosure, including, for example, method 100. The example computer system 400 may be used in implementing one or more of the methods or modules, and any related functions or operations, described herein (e.g., using one or more processor circuits or computer processors of the computer), in accordance with embodiments of the present disclosure. In some embodiments, the major components of the computer system 400 may comprise one or more CPUs 402, a memory subsystem 408, a terminal interface 416, a storage interface 418, an I/O (Input/Output) device interface 420, and a network interface 422, all of which may be communicatively coupled, directly or indirectly, for inter-component communication via a memory bus 406, an I/O bus 414, and an I/O bus interface unit 412.

The computer system 400 may contain one or more general-purpose programmable central processing units (CPUs) 402, some or all of which may include one or more cores 404A, 404B, 404C, and 404D, herein generically referred to as the CPU 402. In some embodiments, the computer system 400 may contain multiple processors typical of a relatively large system; however, in other embodiments the computer system 400 may alternatively be a single CPU system. Each CPU 402 may execute instructions stored in the memory subsystem 408 on a CPU core 404 and may comprise one or more levels of on-board cache.

In some embodiments, the memory subsystem 408 may comprise a random-access semiconductor memory, storage device, or storage medium (either volatile or non-volatile) for storing data and programs. In some embodiments, the memory subsystem 408 may represent the entire virtual memory of the computer system 400 and may also include the virtual memory of other computer systems coupled to the computer system 400 or connected via a network. The memory subsystem 408 may be conceptually a single monolithic entity, but, in some embodiments, the memory subsystem 408 may be a more complex arrangement, such as a hierarchy of caches and other memory devices. For example, memory may exist in multiple levels of caches, and these caches may be further divided by function, so that one cache holds instructions while another holds non-instruction data, which is used by the processor or processors. Memory may be further distributed and associated with different CPUs or sets of CPUs, as is known in any of various so-called non-uniform memory access (NUMA) computer architectures. In some embodiments, the main memory or memory subsystem 408 may contain elements for control and flow of memory used by the CPU 402. This may include a memory controller 410.

Although the memory bus 406 is shown in FIG. 4 as a single bus structure providing a direct communication path among the CPU 402, the memory subsystem 408, and the I/O bus interface 412, the memory bus 406 may, in some embodiments, comprise multiple different buses or communication paths, which may be arranged in any of various forms, such as point-to-point links in hierarchical, star or web configurations, multiple hierarchical buses, parallel and redundant paths, or any other appropriate type of configuration. Furthermore, while the I/O bus interface 412 and the I/O bus 414 are shown as single respective units, the computer system 400 may, in some embodiments, contain multiple I/O bus interface units 412, multiple I/O buses 414, or both. Further, while multiple I/O interface units are shown, which separate the I/O bus 414 from various communications paths running to the various I/O devices, in other embodiments some or all of the I/O devices may be connected directly to one or more system I/O buses.

In some embodiments, the computer system 400 may be a multi-user mainframe computer system, a single-user system, or a server computer or similar device that has little or no direct user interface but receives requests from other computer systems (clients). Further, in some embodiments, the computer system 400 may be implemented as a desktop computer, portable computer, laptop or notebook computer, tablet computer, pocket computer, telephone, smart phone, mobile device, or any other appropriate type of electronic device.

It is noted that FIG. 4 is intended to depict the representative major components of an exemplary computer system 400. In some embodiments, however, individual components may have greater or lesser complexity than as represented in FIG. 4, components other than or in addition to those shown in FIG. 4 may be present, and the number, type, and configuration of such components may vary.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

1. A method, comprising:
receiving a first set of transaction parameters, the first set of transaction parameters indicating a first type of fraud;
generating, based on the transaction parameters, a first set of sample transactions, wherein the first set of sample transactions includes a first sample fraudulent transaction and a first tag, the first tag indicating a type of fraud with which the first sample fraudulent transaction is consistent;
transmitting the first set of sample transactions to an analyzer;
receiving results from the analyzer; and
evaluating, based on the results, performance of the analyzer at detecting the first type of fraud.

2. The method of claim 1, wherein the generating the first sample fraudulent transaction includes:
generating a first transaction counterparty;
generating a first transaction timestamp;
generating a first transaction amount; and
generating a first transaction location.

3. The method of claim 2, wherein:
the first set of transaction parameters include a transaction frequency; and
the generating a transaction timestamp includes:
generating a transaction time gap based on the transaction frequency; and
generating the transaction timestamp based on the transaction time gap and a previous transaction timestamp.

4. The method of claim 3, wherein the generating a transaction time gap based on the transaction frequency includes generating a transaction time gap via a Poisson Distribution, wherein a lambda of the Poisson Distribution is the transaction frequency.

5. The method of claim 2, wherein the generating a transaction counterparty includes selecting a transaction counterparty from a counterparty list using a generalized Bernoulli distribution.

6. The method of claim 2, wherein the generating a transaction amount includes using a LogNormal distribution.

7. The method of claim 1, wherein the first set of sample transactions further includes at least one innocuous transaction.

8. A system, comprising:
one or more processors; and
one or more computer-readable storage media storing program instructions which, when executed by the one or more processors, are configured to cause the one or more processors to perform a method comprising:
receiving a first set of transaction parameters, the first set of transaction parameters indicating a first type of fraud;
generating, based on the transaction parameters, a first set of sample transactions, wherein the first set of sample transactions includes a first sample fraudulent transaction and a first tag, the first tag indicating a type of fraud with which the first sample fraudulent transaction is consistent;
transmitting the first set of sample transactions to an analyzer;
receiving results from the analyzer; and
evaluating, based on the results, performance of the analyzer at detecting the first type of fraud.

9. The system of claim 8, wherein the generating the first sample fraudulent transaction includes:
generating a first transaction counterparty;
generating a first transaction timestamp;
generating a first transaction amount; and
generating a first transaction location.

10. The system of claim 9, wherein:
the first set of transaction parameters include a transaction frequency; and
the generating a transaction timestamp includes:
generating a transaction time gap based on the transaction frequency; and
generating the transaction timestamp based on the transaction time gap and a previous transaction timestamp.

11. The system of claim 10, wherein the generating a transaction time gap based on the transaction frequency includes generating a transaction time gap via a Poisson Distribution, wherein a lambda of the Poisson Distribution is the transaction frequency.

12. The system of claim 9, wherein the generating a transaction counterparty includes selecting a transaction counterparty from a counterparty list using a generalized Bernoulli distribution.

13. The system of claim 9, wherein the generating a transaction amount includes using a LogNormal distribution.

14. The system of claim 8, wherein the first set of sample transactions further includes at least one innocuous transaction.

15. A computer program product, the computer program product comprising one or more computer readable storage media and program instructions collectively stored on the one or more computer readable storage media, the program instructions executable by one or more processors to cause the one or more processors to:
receive a first set of transaction parameters, the first set of transaction parameters indicating a first type of fraud;
generate, based on the transaction parameters, a first set of sample transactions, wherein the first set of sample transactions includes a first sample fraudulent transaction and a first tag, the first tag indicating a type of fraud with which the first sample fraudulent transaction is consistent;
transmit the first set of sample transactions to an analyzer;
receive results from the analyzer; and
evaluate, based on the results, performance of the analyzer at detecting the first type of fraud.

16. The computer program product of claim 15, wherein the generating the first sample fraudulent transaction includes:
generating a first transaction counterparty;
generating a first transaction timestamp;
generating a first transaction amount; and
generating a first transaction location.

17. The computer program product of claim 16, wherein:
the first set of transaction parameters include a transaction frequency; and
the generating a transaction timestamp includes:
generating a transaction time gap based on the transaction frequency; and
generating the transaction timestamp based on the transaction time gap and a previous transaction timestamp.

18. The computer program product of claim 17, wherein the generating a transaction time gap based on the transaction frequency includes generating a transaction time gap via a Poisson Distribution, wherein a lambda of the Poisson Distribution is the transaction frequency.

19. The computer program product of claim 16, wherein the generating a transaction counterparty includes selecting a transaction counterparty from a counterparty list using a generalized Bernoulli distribution.

20. The computer program product of claim 16, wherein the generating a transaction amount includes using a LogNormal distribution.
